(19) United States
(12) Patent Application Publication
(10) Pub. No.: US 2023/0088065 A1
(43) Pub. Date: Mar. 23, 2023

(54) Systems And Methods To Enhance Operations Of An Advanced Driver Assistance System (ADAS)

(71) Applicant: Ford Global Technologies, LLC, Dearborn, MI (US)

(72) Inventor: Aed Dudar, Canton, MI (US)

(73) Assignee: Ford Global Technologies, LLC, Dearborn, MI (US)

(21) Appl. No.: 17/483,477

(22) Filed: Sep. 23, 2021

(51) Int. Cl. B60W 40/13; B60W 30/12; B60W 30/14; B60W 30/09; B60W 50/00

(52) U.S. Cl. CPC B60W 40/13; B60W 30/12; B60W 30/14; B60W 30/09; B60W 50/0098; B60W 2530/10; B60W 2050/0075

(57) ABSTRACT

The disclosure is generally directed to an advanced driver assistance system (ADAS) enhancement system. In an example method of operation, a processor of the ADAS enhancement system obtains information about a laden weight of a vehicle, identifies a setting associated with an operation of an ADAS of the vehicle (a braking operation, a cruising speed control operation, a lane maintaining operation, etc.) and modifies the first setting based on the laden weight of the vehicle. For example, the ADAS enhancement system may increase a first braking distance set by the ADAS to a second braking distance system based on the laden weight of the vehicle. As another example, the ADAS enhancement system may change a first level of responsiveness to an action performed by the driver of the vehicle to a second level of responsiveness in proportion to the weight of a cargo item in the vehicle.

### BACKGROUND

Modern vehicles often include an advanced driver assistance system (ADAS) that can assist a driver of a vehicle perform various operations. More particularly, a typical ADAS is configured to receive various types of information from sensors and/or cameras and use the information to perform operations such as cruise control, collision avoidance, and self-parking.

It is desirable for ADAS to take advantage of multiple sources of information prior to causing the vehicle to take appropriate action.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows a vehicle that includes an ADAS and an ADAS enhancement system in accordance with an embodiment of the disclosure.

FIG. 2 illustrates a comparison between a first braking distance “d1” of a vehicle when in an unloaded condition to a second braking distance “d2” when the vehicle is carrying a cargo item.

FIG. 3 illustrates a comparison between a first braking distance “d3” of a vehicle when the vehicle is traveling at a first speed and a second braking distance “d4” when the vehicle is traveling at a second speed that is greater than the first speed.

FIG. 4 illustrates a comparison between a first braking distance “d5” and a second braking distance “d6” of a vehicle when a trailer is attached to the vehicle.

FIG. 5 illustrates a comparison between a first braking distance “d5” and a second braking distance “d7” when a cargo item is removed from the vehicle.

FIG. 6 shows an example display that may be displayed upon a display screen of an infotainment system of a vehicle.

FIG. 7 shows another example display that may be displayed upon a display screen of an infotainment system of a vehicle.

FIG. 8 shows an example switch cluster that may be used by a driver of a vehicle to set a personal preference with respect to a cruise control operation performed by an ADAS.

FIG. 9 shows some example components that can be included in a vehicle in accordance with an embodiment of the disclosure.

### DETAILED DESCRIPTION

### Overview

In terms of a general overview, embodiments described in this disclosure are generally directed to an advanced driver assistance system (ADAS) enhancement system. In an example method of operation, a processor of the ADAS enhancement system obtains information about a laden weight of a vehicle. The information about the laden weight may be obtained from a weight sensor that can be a part of the vehicle. The processor then identifies a setting associated with an operation of an ADAS of the vehicle (a braking operation, a cruising speed control operation, a lane maintaining operation, etc.) and modifies the setting based on the laden weight of the vehicle. In one example implementation, the ADAS enhancement system may increase a first braking distance set by the ADAS to a second braking distance system based on the laden weight of the vehicle. In another example implementation, the ADAS enhancement system may change a first level of responsiveness to an action performed by the driver of the vehicle to a second level of responsiveness in proportion to the weight of a cargo item in the vehicle.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “sensor” may be used interchangeably with the word “detector.” Either word as used in this disclosure refers to various devices, such as an ultrasonic sensor that may be used to detect an object by using ultrasonic waves, a radar detector that may be used to detect an object by using radar signals, and an imaging device, such as a camera that is used to capture an image (or a video clip) of an object for image processing by an image processing element to detect the object. The word “data” may be used interchangeably with the word “information.” Either word pertains to any of various forms of input to a processor. The word “responsiveness” as used herein must be understood as being equivalent to various other words such as “sensitivity,” and “resolution.” The phrase “human machine interface” (HMI) as used herein encompasses a graphical user interface (GUI) as well as various other interfaces that may be provided on various devices including, for example, in an infotainment system provided in a vehicle. It should be understood that the word “example” as used herein is intended to be non-exclusionary and non-limiting in nature.

The word “vehicle” as used in this disclosure can pertain to any one of various types of vehicles such as cars, vans, sports utility vehicles, trucks, electric vehicles, gasoline vehicles, and hybrid vehicles. The phrase “Advanced Driver Assistance System” (ADAS) as used herein refers to a system that provides various types of assistance to a driver of a vehicle. The level of assistance and type of assistance provided by an ADAS can vary depending upon a level of driving automation provided in a vehicle. The Society of Automotive Engineers (SAE) defines six levels of driving automation ranging from Level 0 (fully manual) to Level 5 (fully autonomous). These levels have been adopted by the U.S. Department of Transportation. Certain features of some levels, particularly higher levels such as Level 4 and Level 5, may not yet be provided in vehicles used by the public.

Level 0 (L0) vehicles are manually controlled vehicles having no driving related automation. Driver assistance may be provided by devices such as, for example a parking sensor and a camera. The devices can provide features that may be used for operations such as capturing images of objects outside the vehicle and providing warning sounds when certain types of objects are detected outside the vehicle (a pedestrian, for example).

Level 1 (L1) vehicles incorporate some features, such as cruise control, but a human driver retains control of most driving and maneuvering operations. An ADAS in a L1 vehicle may provide features such as adaptive cruise control.

Level 2 (L2) vehicles are partially automated with certain driving operations such as steering, braking, and lane control being controlled by a vehicle computer. The driver retains some level of control of the vehicle and may override certain operations executed by the vehicle computer. An ADAS in a L2 vehicle may provide features such as, for example, highway assist, autonomous obstacle avoidance, and autonomous parking.

Level 3 (L3) vehicles provide conditional driving automation but are smarter in terms of having an ability to sense a driving environment and certain driving situations.

Level 4 (L4) vehicles can operate in a self-driving mode and include features where the vehicle computer takes control during certain types of equipment failures. The level of human intervention is very low. An ADAS for a L4 vehicle may provide features such as, for example, an automatic valet parking.

Level 5 (L5) vehicles are fully autonomous vehicles that do not involve human participation.

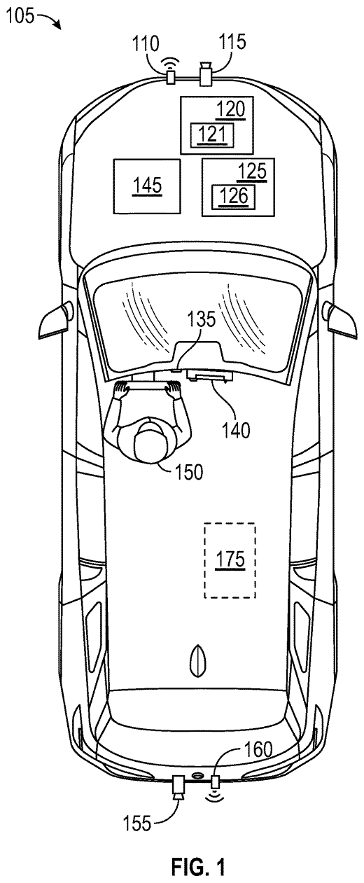

FIG. 1 shows a vehicle 105 that includes an ADAS 120 and an ADAS enhancement system 125 in accordance with an embodiment of the disclosure. The vehicle 105 may be any of various types of vehicles that include various detectors for detecting various types of obstacles and hazards that may be encountered by a driver 150 when operating the vehicle 105. A few example detectors that may be provided in the vehicle 105 can include a weight sensor 175, a rear-facing camera 155 mounted upon a trunk portion of the vehicle 105 (above a license plate, for example), a radar detector 160 mounted upon or under a rear bumper of the vehicle 105, a front-facing camera 115 mounted upon a hood portion of the vehicle 105 (in a grille or a front bumper, for example), and a radar detector 110 mounted upon a front bumper of the vehicle 105. In some implementations, the radar detector 110 (and/or the radar detector 160) may be replaced by an ultrasonic detector. It must be understood that subject matter disclosed herein with respect to a radar detector is equally applicable to an ultrasonic detector.

The vehicle 105 may further include components such as, for example, a vehicle computer 145, an infotainment system 140, and a beeper 135. These components may be communicatively coupled to the ADAS 120 and the ADAS enhancement system 125. The weight sensor 175 may be arranged to detect weight parameters of the vehicle 105 under various conditions. In a first example condition, the vehicle 105 is unoccupied, and contains no cargo items (luggage, packages, etc.). In this first condition, the weight sensor 175 detects an unladen weight of the vehicle 105. The unladen weight may also be referred to as a tare weight.

In a second example condition, the vehicle 105 is unoccupied and contains one or more cargo items, such as, for example, a suitcase in a trunk of a sedan (when the vehicle 105 is a sedan) or a package in a cargo area of a delivery van (when the vehicle 105 is a delivery van). In this second condition, the weight sensor 175 detects a first laden weight of the vehicle 105. The phrase “laden weight” generally refers to the weight of the vehicle 105 when an item having weight is placed upon the vehicle 105 (in this case, the cargo items).

In a third example condition, the vehicle 105 contains one or more occupants (such as the driver 150 and a passenger when present) and also contains one or more cargo items. In this third condition, the weight sensor 175 detects a second laden weight of the vehicle 105. The second laden weight corresponds to a weight of the occupants added to either the tare weight (when the vehicle 105 is unoccupied and contains no cargo items) or the first laden weight (when the vehicle 105 is unoccupied and contains cargo items).

In one example implementation in accordance with the disclosure, a weight parameter detected by the weight sensor 175 such as, for example, the tare weight, the first laden weight, and/or the second laden weight, is conveyed to the ADAS enhancement system 125 for executing one or more operations in accordance with the disclosure. An example operation can involve the ADAS enhancement system 125 communicating and interacting with the ADAS 120 to increase a first braking distance to a second braking distance. The first braking distance may be determined by the ADAS 120 using conventional techniques that may not take into consideration certain factors, including a weight of the vehicle 105.

The second braking distance, which is greater than the first braking distance, may be determined by the ADAS enhancement system 125 using an evaluation procedure in accordance with the disclosure that is based on the weight parameters provided by the weight sensor 175. More particularly, in one embodiment, the second braking distance may be determined by the ADAS enhancement system 125 in proportion to the laden weight of the vehicle 105. Accordingly, the second braking distance will be greater for a second laden weight that is greater than a first laden weight, and vice-versa. A heavier vehicle requires a greater braking distance than a lighter vehicle.

In another example implementation in accordance with the disclosure, a weight parameter is provided to the ADAS enhancement system 125 by a system or device other than the weight sensor 175. In an example scenario, the weight parameter (a laden weight, for example) is provided to the ADAS enhancement system 125 by a vehicle weighing apparatus embedded in the ground (such as, for example, in a weighing station located beside an interstate highway for weighing commercial delivery trucks). In this implementation, the ADAS enhancement system 125 may use the weight parameter (the laden weight) provided by the vehicle weighing apparatus to determine the second braking distance. The second braking distance may be determined in proportion to the laden weight. Consequently, the second braking distance will be greater for a greater laden weight and vice-versa.

In yet another example implementation in accordance with the disclosure, weight information provided to the ADAS enhancement system 125 by the weight sensor 175 (or by the vehicle weighing apparatus) includes a weight distribution upon a chassis of the vehicle 105. In one case, the vehicle 105 can be, for example, a transport vehicle loaded with heavy cargo items on a cargo bed that is located towards the rear of the vehicle 105. In another case, the vehicle 105 can be, for example, a construction vehicle (a front loader, for example) that carries a load in the front portion of the vehicle 105 (in a bucket, for example).

The braking characteristics of the back-heavy transport vehicle is different in comparison to the braking characteristics of the front-heavy construction vehicle. The ADAS enhancement system 125 may use the weight distribution information to determine the second braking distance. The second braking distance for the back-heavy vehicle may be different than the second braking distance for the front-heavy vehicle. In some cases, the second braking distance may be determined based on a combination of the weight distribution and the laden weight of the vehicle 105.

Other example factors that may be used by the ADAS enhancement system 125 to determine the second braking distance in lieu of, or in combination with, the laden weight and/or the weight distribution of the vehicle 105, can include brake system characteristics (air brakes, hydraulic brakes, disc brakes, brake pad locations, etc.), tire characteristics (radial, all-weather diameter, width, etc.), vehicle dimensions (wide body, low height, length, etc.) and attachments (a trailer, for example). Such information may be obtained by the ADAS enhancement system 125 from various sources, such as, for example, from the vehicle computer 145, from input provided by a manufacturer of the vehicle 105, and/or from various sensors and detectors provided in the vehicle 105 (brake sensors, cameras, transducers, etc.).

The vehicle computer 145 may perform various functions of the vehicle 105, such as controlling engine operations (fuel injection, speed control, emissions control, braking, etc.), managing climate controls (air conditioning, heating etc.), activating airbags, and issuing warnings (check engine light, bulb failure, low tire pressure, etc.). The vehicle computer 145 may also provide various types of information to the ADAS 120 and the ADAS enhancement system 125, such as, for example, information pertaining to one or more actions performed by the driver 150.

In an example situation, the vehicle computer 145 may determine that the driver 150 is executing a braking operation upon the vehicle 105. The determination may be made, for example, by monitoring a fuel injection system and/or a braking system of the vehicle 105. Information pertaining to the braking operation may be conveyed by the vehicle computer 145 to the ADAS 120 and the ADAS enhancement system 125 (in some cases, in response to a request from the ADAS 120 and/or the ADAS enhancement system 125). In an example scenario, the ADAS enhancement system 125 may evaluate the information and cooperate with the ADAS 120 and the vehicle computer 145 to modify a braking distance of the vehicle 105.

The infotainment system 140 may include a combination of various entertainment elements (such as a radio, streaming audio solutions, etc., and USB access ports for digital audio devices) with elements, such as a navigation system that provides navigation instructions and maps upon a display screen of the infotainment system 140.

The various detectors, which are communicatively coupled to the ADAS 120 and/or the ADAS enhancement system 125, are configured to provide information that may be evaluated by the ADAS 120 and/or the ADAS enhancement system 125 for identifying various driving conditions. For example, the radar detector 160 and/or the radar detector 110 may provide signals to the ADAS 120 and the ADAS enhancement system 125 upon detecting another vehicle traveling hazardously close to the vehicle 105. A processor 121 that is a part of the ADAS 120 (and a processor 126 that is a part of the ADAS enhancement system 125) may evaluate these signals and warn the driver 150. The warning may be provided, for example, in the form of audio beeps through the beeper 135 and/or a warning message displayed upon a display screen of the infotainment system 140. The warning message may, for example, advise the driver 150 to switch lanes in order to avoid a collision with the other vehicle.

As another example, the front-facing camera 115 and/or the rear-facing camera 155 may provide images to the ADAS 120 and/or the ADAS enhancement system 125 that are evaluated by the processor 121 and the processor 126 to detect a hazard that warrants a responsive action being taken upon the vehicle 105 (braking, for example). In one implementation, the front-facing camera 115 and/or the rear-facing camera 155 may provide the images to the ADAS 120 and/or the ADAS enhancement system 125 in the form of a video stream. The processor 121 of the ADAS 120 may evaluate the video stream in real time to identify a hazard that may warrants automatic execution of a responsive action by the vehicle 105.

The processor 126 of the ADAS enhancement system 125 may evaluate the video stream in real time to determine if interaction with the ADAS 120 is warranted. In an example operation in accordance with the disclosure, the interaction may involve pre-empting, replacing, or modifying a command issued by the ADAS 120. The command issued by the ADAS 120 can, for example, be a command to the vehicle computer 145 and/or a brake system of the vehicle 105 to execute a braking operation. The ADAS 120 may identify a first braking distance based on a threshold distance value associated with a separation distance between the vehicle 105 and another vehicle. The threshold distance value may fail to take into consideration factors such as weight parameters provided by the weight sensor 175, brake system characteristics, tire characteristics, vehicle dimensions, a trailer attachment, and hazardous road conditions (icy road surface, water-logged road). The ADAS enhancement system 125 modifies the first braking distance to a greater second braking distance based on such factors in accordance with disclosure.

Modification of the first braking distance to the second braking distance may be executed in various ways. In one example procedure, the ADAS enhancement system 125 communicates with the vehicle computer 145 via commands that are evaluated and executed by the vehicle computer 145 (such as, for example, a command that overrides a braking instruction from the ADAS 120 and increases a braking distance to ‘xxx’ meters“).

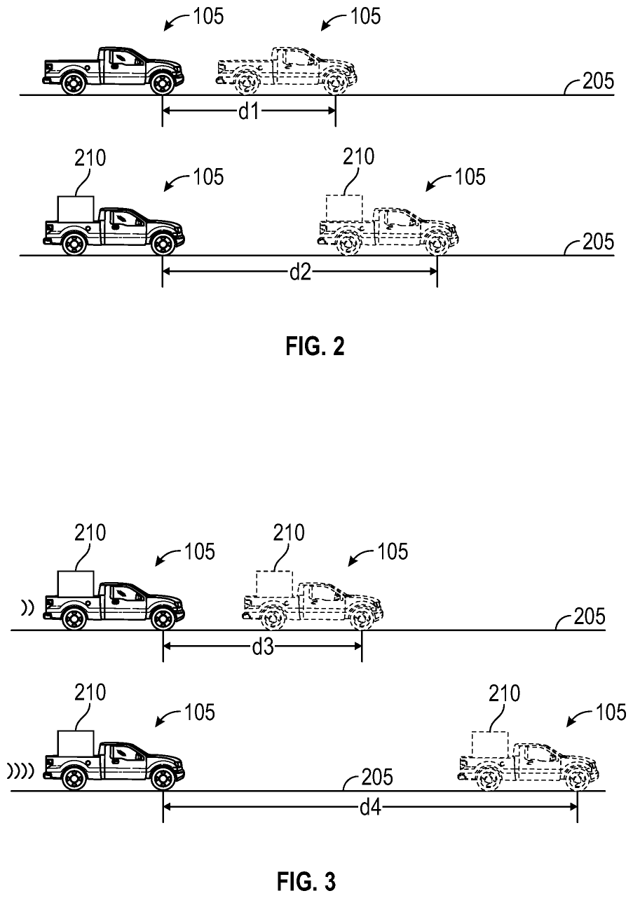

FIG. 2 illustrates a comparison between a first braking distance “d1” of the vehicle 105 when in an unloaded condition, to a second braking distance “d2” when the vehicle 105 is carrying a cargo item 210. The second braking distance “d2” is greater than the first braking distance “d1” in proportion to factors such as the laden weight of the vehicle 105 (proportional to the weight of the cargo item 210), weight distribution (the cargo item 210 is located on a cargo bed towards the rear portion of the vehicle 105), a surface condition of the road 205 (icy, wet, gravel, sand, etc.), and vehicle characteristics (brakes, tires, height, etc.).

The ADAS 120 may determine the first braking distance “d1” based on hypothetical calculations that fail to take into consideration factors such as the laden weight of the vehicle 105, brake system characteristics, tire characteristics, vehicle dimensions, a trailer attachment, and road conditions. The ADAS enhancement system 125 modifies the first braking distance “d1” to the greater second braking distance “d2” based on such factors in accordance with disclosure. In the illustrated scenario, where the cargo item 210 placed on the vehicle 105 causes the laden weight of the vehicle 105 to double, the second braking distance “d2” can be set by the ADAS enhancement system 125 to about twice the first braking distance “d1.”

FIG. 3 illustrates a comparison between a first braking distance “d3” of the vehicle 105 when the vehicle 105 is traveling at a first speed and a second braking distance “d4” when the vehicle 105 is traveling at a second speed that is greater than the first speed. In the illustrated example scenario, where the laden weight of the vehicle 105 and the location of the cargo item 210 remains unchanged, the second braking distance “d4” is greater than the first braking distance “d3” in proportion to the difference in magnitude between the first speed and the second speed. Other factors such as a surface condition of the road 205 and vehicle characteristics (brakes, tires, height, etc.) can also come into play when comparing “d4” to “d3.” The ADAS enhancement system 125 may use such information to modify the first braking distance “d3” (set by the ADAS 120) to the second braking distance “d4.” In an example scenario, the second braking distance “d4” is about four times the first braking distance “d3” when the second speed is twice the first speed.

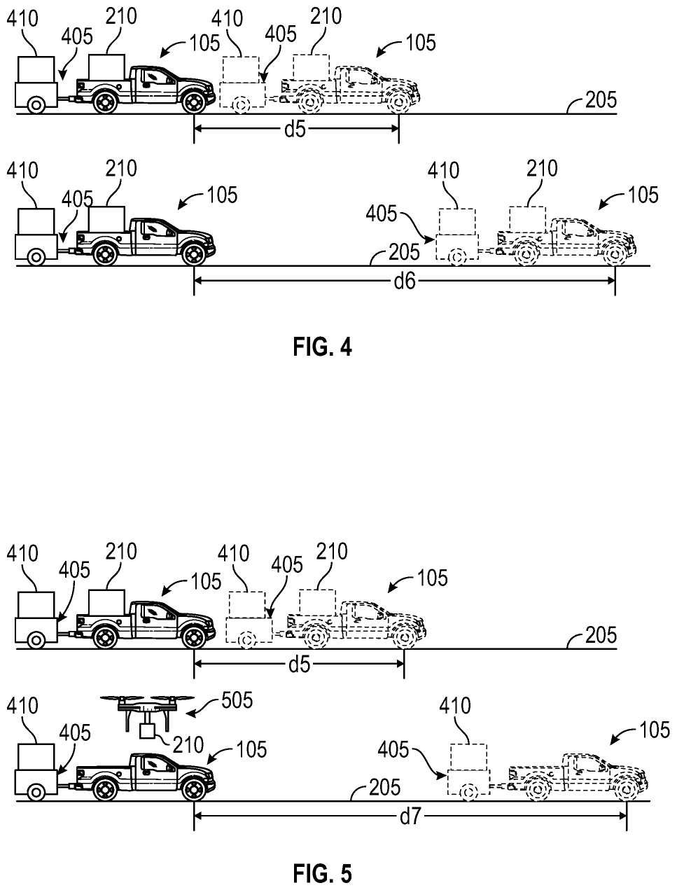

FIG. 4 illustrates a comparison between a first braking distance “d5” and a second braking distance “d6” of the vehicle 105 when a trailer 405 is attached to the vehicle 105. The first braking distance “d5” is determined by the ADAS 120 and is applicable in this example scenario, to the vehicle 105 when the cargo item 210 is located on the cargo bed of the vehicle 105 and a cargo item 410 is located on the trailer 405 that is attached to the vehicle 105. The second braking distance “d6” is determined by the ADAS enhancement system 125 and is applicable to the vehicle 105 when the vehicle 105 has an identical configuration (cargo item 210 on the cargo bed of the vehicle 105 and the cargo item 410 placed on the trailer 405).

The ADAS enhancement system 125 may modify the first braking distance “d5” (set by the ADAS 120) to the second braking distance “d6” based on factors such as the laden weight of the vehicle 105, vehicle characteristics, and road surface characteristics. In the illustrated scenario, the ADAS enhancement system 125 may also take into additional factors that may be associated with the trailer 405 and the cargo item 410 placed on the trailer 405. Example additional factors can include a laden weight of the trailer 405 (an unloaded trailer can behave differently in comparison to one carrying a load), physical characteristics of the trailer 405 (length, height, unladen weight, wheel base, wheel size, tires, etc.), physical characteristics of a hitch used to couple the trailer 405 to the vehicle 105, and movement characteristics of the trailer 405 with respect to the vehicle 105. The movement characteristics of the trailer 405 can include sway, tilt, and braking characteristics (depends, for example, whether brakes are provided on the trailer 405 or not).

FIG. 5 illustrates a comparison between a first braking distance “d5” and a second braking distance “d7” when the cargo item 305 is removed from the vehicle 105. The first braking distance “d5” has been described above with reference to FIG. 4. In this illustrated scenario, the second braking distance “d7” is different than the second braking distance “d6” shown in FIG. 4 due to a change in the laden weight of the vehicle 105. The change in the laden weight in this case, is caused by removal of the cargo item 210 from the cargo bed of the vehicle 105. In another case, the change in the laden weight can be caused by depositing of an additional cargo item on to the cargo bed of the vehicle 105 (to add to the cargo item 210 that is present already). In yet another case, a change in the laden weight of the trailer 405 can be caused by removal of the cargo item 410 from the trailer 405 or depositing of an additional cargo item on to the trailer 405.

In the illustrated example scenario, removal of the cargo item 210 from the cargo bed of the vehicle 105 is carried out by employing an unmanned aerial vehicle (UAV) 505. The UAV 505 may land upon the cargo bed of the vehicle 105 (or hover above the cargo bed of the vehicle 105) to remove the cargo item 210 either when the vehicle 105 is stationary or when in motion.

Removal of the cargo item 210 from the cargo bed of the vehicle 105 reduces the laden weight of the vehicle 105. Consequently, the second braking distance “d7” shown in FIG. 5 can be less than the second braking distance “d6” shown in FIG. 4. The change in laden weight scenario described above with respect to the vehicle 105 having the trailer 405 attached is equally applicable to the vehicle 105 without the trailer 405 attached (as shown in FIG. 2 and FIG. 3)

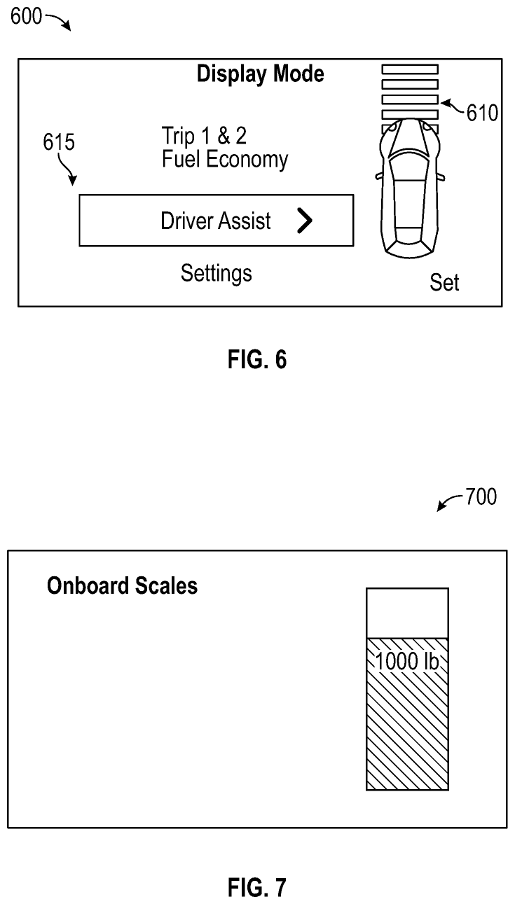

FIG. 6 shows an example display 600 that may be displayed upon a display screen of the infotainment system 140 of the vehicle 105. The display 600 can include various items such as a Driver Assist item 615 that pertains to the ADAS 120. The driver 150 may make a selection upon the display 600, and the ADAS 120 may respond by performing certain actions automatically such as, for example, setting a speed of the vehicle 105 to a cruising speed set by the driver 150, setting an automatic braking distance corresponding to the speed setting, and setting a level of responsiveness to an action performed by the driver of the vehicle (veering into an adjacent lane, drowsiness, etc.). The level of responsiveness to some actions may be displayed on graphical representation 610 and in some cases, the driver 150 may be provided an option to modify a setting.

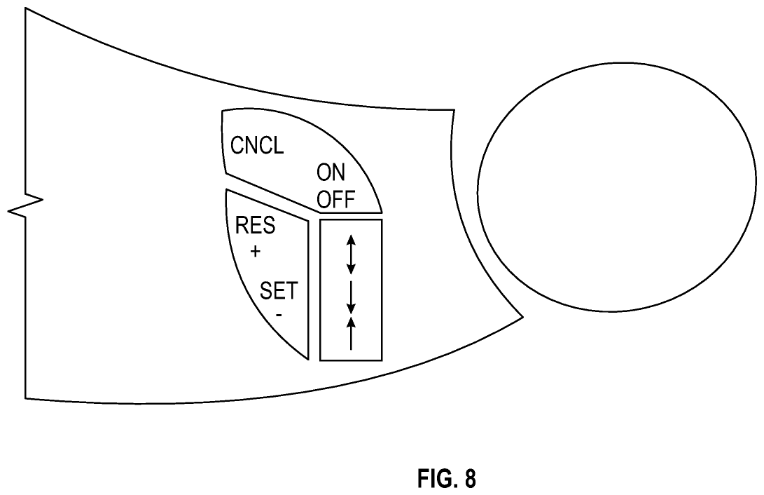

FIG. 7 shows another example display 700 that may be displayed upon a display screen of the infotainment system 140 of the vehicle 105. The display 700 pertains to a payload carried by the vehicle 105 and can be a part of a payload and tongue weigh detection feature provided in the vehicle 105. The payload and tongue weigh detection feature provides an indication to the river 150, of an approximate weight of occupants and cargo items imposed upon the wheels of the vehicle 105 and may also provide an indication of a tongue weight that is imposed upon a hitch when the trailer 405 is attached to the vehicle 105. The driver 150 may use the displayed information to make decisions, such as decreasing a load or reinforcing a hitch assembly.

Operations and features such as the ones described above with reference to FIG. 6 and FIG. 7 are typically carried out by the ADAS 120. The ADAS enhancement system 125 operates to enhance these operations and features. In one example scenario, the ADAS enhancement system 125 changes a first braking distance set by the ADAS 120 as a part of a collision avoidance operation and/or a cruise control operation, to a second braking distance that is greater than the first braking distance. The second braking distance is determined by the ADAS enhancement system 125 based on weight information obtained from the weight sensor 175 (or from another source, such as a weighing station) and other factors (speed of vehicle 105, road surface condition, etc.).

The second braking distance that is determined by the ADAS enhancement system 125 can be linearly (or non-linearly) proportional to the laden weight. Accordingly, in one case, where the second braking distance is determined on a linear basis, the second braking distance that is determined by the ADAS enhancement system 125 when the laden weight of the vehicle 105 is 1000 pounds (for example) can be twice as much as the braking distance used when the laden weight of the vehicle 105 is half as much (500 pounds). In another case, where the second braking distance is determined on a non-linear basis, the second braking distance that is determined by the ADAS enhancement system 125 when the laden weight of the vehicle 105 is 1000 pounds (for example) can be four times as much as the breaking distance used when the laden weight of the vehicle 105 is half as much (500 pounds).

In an example implementation, the second braking distance and information pertaining to the increase in braking distance may be displayed on the display 700. The information may, for example, alert the driver 150 that the braking distance has been increased on the basis of a cargo item being transported in the vehicle 105 (or in an attached trailer).

In another example scenario, the ADAS enhancement system 125 changes a first level of responsiveness that may have been set by the ADAS 120 as a part of a lane maintaining operation to a second level of responsiveness based on weight information obtained from the weight sensor 175 (or from another source, such as a weighing station) and other factors (speed of vehicle 105, road surface condition, etc.). The first level of responsiveness set by the ADAS 120 may involve a first autonomous steering correction operation that is carried out in a first manner (steering angle, rate of change of direction, etc.) when the vehicle 105 crosses a lane marking. The second level of responsiveness set by the ADAS enhancement system 125 overrides the first level of responsiveness set by the ADAS 120 and may involve a second autonomous steering correction operation. The characteristics of the second autonomous steering correction operation (steering angle, rate of change of direction, etc.) is different than the first level of responsiveness and may be determined by the ADAS enhancement system 125 based on a laden weight of the vehicle 105, weight of a trailer, if attached to the vehicle 105, and other factors (described above). The second level of responsiveness may lead to, for example, a reduction in an amount of fishtailing by the vehicle 105 and/or the trailer 405.

Features such as the second braking distance and the second level of responsiveness that are set by the ADAS enhancement system 125 based on a first laden weight of the vehicle 105 (and/or the trailer 405) at a first instance in time, may be modified by the ADAS enhancement system 125 based on a second laden weight of the vehicle 105 (and/or the trailer 405) at a second instance in time. In an example scenario, the second instance in time corresponds to a time when the cargo item 210 has been removed from (or added to) the cargo bed of the vehicle 105 by the UAV 505 as illustrated in FIG. 5.

FIG. 8 shows an example switch cluster 800 that may be used by the driver 150 to set a personal preference with respect to a cruise control operation performed by the ADAS 120. The switch cluster 800 is typically provided on a steering column of the vehicle 105 and allows the driver 150 to manually set a cruising speed of the vehicle 105. The ADAS 120 responds to the input provided by the driver 150 and executes cruise control operations upon the vehicle 105.

In another scenario, some controls that pertain to the ADAS 120 may be provided on a touchscreen of the infotainment system 140. An example control allows the driver 150 to provide an input pertaining to an operation controlled by the ADAS 120 such as, for example, an autonomous braking operation or a lane centering operation. The input can be, for example, one of several levels of responsiveness (or sensitivity) such as high, normal, and low. When a high level of responsiveness is selected by the driver 150, the ADAS 120 may respond to a veering action of the vehicle 105 by adjusting a steering system of the vehicle 105 in a step function format for re-centering the vehicle 105 in a lane. In accordance with the disclosure, the ADAS enhancement system 125 may override the input provided by the driver 150 (and an action performed by the ADAS 120 in accordance with the input) and execute an action that is based on factors such as weight information obtained from the weight sensor 175 (or from another source, such as a weighing station) and other factors (speed of vehicle 105, road surface condition, etc.).

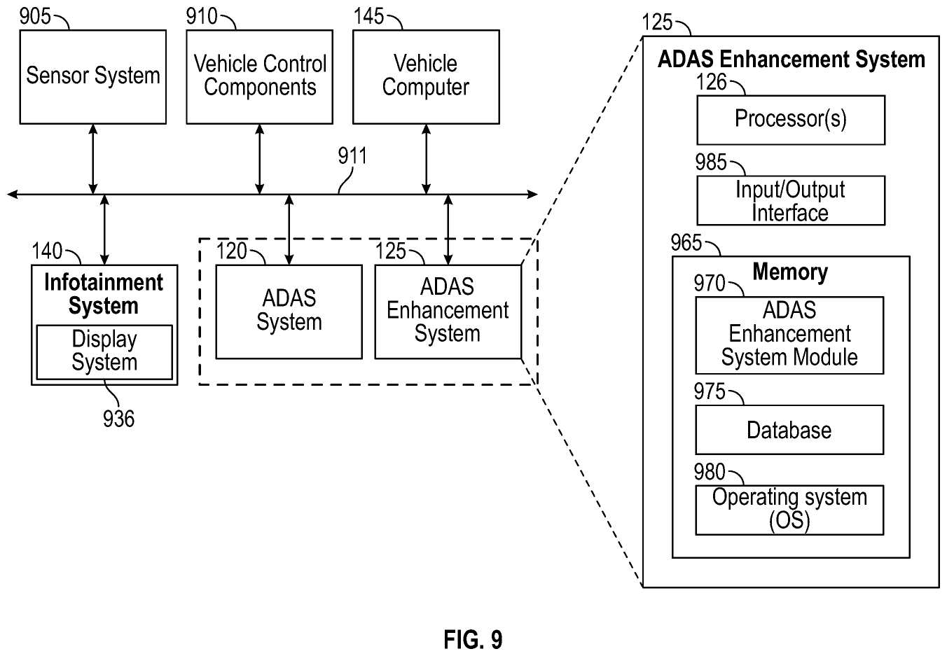

FIG. 9 shows some example components that can be included in the vehicle 105 in accordance with an embodiment of the disclosure. The example components can include a sensor system 905, vehicle control components 910, the vehicle computer 145, the infotainment system 140, the ADAS 120, and the ADAS enhancement system 125. The various components are communicatively coupled to each other via one or more buses such as an example bus 911. The bus 911 may be implemented using various wired and/or wireless technologies. For example, the bus 911 can be a vehicle bus that uses a controller area network (CAN) bus protocol, a Media Oriented Systems Transport (MOST) bus protocol, and/or a CAN flexible data (CAN-FD) bus protocol. Some or all portions of the bus 911 may also be implemented using wireless technologies such as Bluetooth®, Bluetooth®, Ultra-Wideband, Wi-Fi, Zigbee®, or near-field-communications (NFC).

The infotainment system 140 can include a display system 936 having a GUI for carrying out various operations. The GUI may be used, for example, by the driver 150 to input a level of responsiveness for the ADAS 120 to perform an operation.

The sensor system 905 can include various types of sensors such as, for example, the weight sensor 175, the rear-facing camera 155, the radar detector 160, the front-facing camera 115, and the radar detector 110 shown in FIG. 1.

The vehicle control components 910 can include various components and systems associated with driving functions of the vehicle 105 (such as, for example, the engine, brakes, accelerator, and fuel injection) and various other functions of the vehicle 105 (such as, for example, stocks and struts whose characteristics can be controlled for varying a performance of the vehicle 105). The various components may be controlled, activated, and/or operated by the vehicle computer 145, the ADAS 120, and the ADAS enhancement system 125.

In one implementation, the ADAS enhancement system 125 can be an independent device (enclosed in an enclosure, for example). In another implementation, some or all components of the ADAS enhancement system 125 can be housed, merged, or can share functionality, with the ADAS 120 and/or the vehicle computer 145. For example, an integrated unit that combines the functionality of the ADAS enhancement system 125 with that of the ADAS 120 can be operated by a single processor and a single memory device. In the illustrated example configuration, the ADAS enhancement system 125 includes the processor 126, an input/output interface 985, and a memory 965.

The input/output interface 985 is configured to provide communications between the ADAS enhancement system 125 and other components such as the sensor system 905 (for receiving weight information from the weight sensor 175, for example), the vehicle control components 910 (for overriding commands issued by the ADAS 120 and for providing enhanced operations such as, for example, a greater braking distance), the infotainment system 140, and the ADAS 120.

The memory 965, which is one example of a non-transitory computer-readable medium, may be used to store an operating system (OS) 980, a database 975, and various code modules such as an ADAS enhancement system module 970. The code modules are provided in the form of computer-executable instructions that can be executed by the processor 126 for performing various operations in accordance with the disclosure.

The ADAS enhancement system module 970 may be executed by the processor 126 for performing various operations in accordance with the disclosure. Some example operations are described above.

The database 975 may be used to store information such as, for example, weight information related to the vehicle 105 and the trailer 405, braking distance information, responsiveness information, and road surface information, that can be accessed and used by the processor 126 when executing the ADAS enhancement system module 970.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 965, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
obtaining, by a processor, information about a laden weight of a vehicle;
identifying, by the processor, a first setting associated with a first operation of an advanced driver assistance system (ADAS) of the vehicle; and
modifying, by the processor, the first setting associated with the first operation of the ADAS based on the laden weight of the vehicle.

2. The method of claim 1, wherein the processor is located in the vehicle, wherein information about the laden weight is obtained from a weight sensor, wherein the ADAS comprises a braking system, a cruise control system, and/or a lane maintaining system, wherein the information about the laden weight of the vehicle comprises a weight of a cargo item, wherein the first setting is set by a driver of the vehicle, wherein the first operation of the ADAS is one of a braking operation, a cruising speed control operation, or a lane maintaining operation, and wherein modifying the first setting associated with the first operation comprises modifying an operation of the braking system based on the weight of the cargo item and/or a road surface condition that impacts the operation of the braking system.

3. The method of claim 2, wherein the vehicle includes a cargo area and the weight of the cargo item that impacts the operation of the braking system comprises a first cargo item placed in the cargo area of the vehicle.

4. The method of claim 3, wherein the ADAS provides a first braking distance when the first cargo item is placed in the cargo area of the vehicle, and wherein modifying the operation of the ADAS based on the laden weight of the vehicle comprises increasing the first braking distance to a second braking distance in proportion to the weight of the first cargo item.

5. The method of claim 3, wherein the ADAS provides a first level of responsiveness to an action performed by the driver of the vehicle and wherein modifying the first setting associated with the first operation of the ADAS comprises changing the first level of responsiveness to a second level of responsiveness in proportion to the weight of the first cargo item.

6. The method of claim 5, wherein changing the first level of responsiveness to the second level of responsiveness comprises changing the first setting that is set by the driver of the vehicle to a second setting that is determined by the processor.

7. The method of claim 3, wherein the weight of the cargo item that impacts the operation of the braking system further comprises a second cargo item that is one of added to the cargo area of the vehicle, removed from the cargo area of the vehicle, placed on a trailer that is attached to the vehicle, or removed from the trailer that is attached to the vehicle.

8. A method comprising:
identifying, by a processor, a first operation of an advanced driver assistance system (ADAS) of a vehicle;
determining, by the processor, a laden weight of the vehicle; and
modifying, by the processor, the first operation of the ADAS based on the laden weight of the vehicle.

9. The method of claim 8, wherein the processor is located in the vehicle, wherein information about the laden weight is obtained from a weight sensor, and wherein the first operation of the ADAS comprises an automatic braking operation.

10. The method of claim 8, wherein modifying the first operation of the ADAS based on the laden weight of the vehicle comprises increasing a first braking distance to a second braking distance when the ADAS is in operation.

11. The method of claim 8, wherein modifying the first operation of the ADAS based on the laden weight of the vehicle comprises overriding a level of responsiveness that is set by a driver of the vehicle.

12. The method of claim 8, wherein the first operation of the ADAS comprises an automatic braking operation, and wherein the method further comprises:
identifying, by the processor, a second operation of the ADAS, the second operation comprising one of an automatic cruise control operation or an automatic lane maintaining operation; and
modifying, by the processor, the second operation of the ADAS based on the laden weight of the vehicle.

13. The method of claim 12, wherein modifying the second operation of the ADAS based on the laden weight of the vehicle comprises modifying a manually-controlled feature associated with the one of the automatic cruise control operation or the automatic lane maintaining operation.

14. A vehicle comprising:
an advanced driver assistance system (ADAS); and
an ADAS enhancement system in communication with the ADAS, the ADAS enhancement system comprising:
a memory that stores computer-executable instructions; and
a processor configured to access the memory and execute the computer-executable instructions to perform operations comprising:
determining a laden weight of the vehicle; and
modifying an operation of the ADAS based on the laden weight of the vehicle.

15. The vehicle of claim 14, wherein modifying the operation of the ADAS comprises modifying an operation of a braking system of the vehicle based on the laden weight of the vehicle.

16. The vehicle of claim 15, wherein modifying the operation of the braking system comprises increasing a first braking distance to a second braking distance in proportion to the laden weight of the vehicle.

17. The vehicle of claim 15, wherein the laden weight of the vehicle includes a first cargo item placed in a cargo area of the vehicle and wherein modifying the operation of the braking system comprises increasing a first braking distance that is set by the ADAS when the first cargo item is placed in the cargo area of the vehicle to a second braking distance in proportion to a weight of the first cargo item.

18. The vehicle of claim 17, wherein the laden weight of the vehicle further comprises a second cargo item that is one of additionally placed in the cargo area of the vehicle, removed from the cargo area of the vehicle, placed on a trailer that is attached to the vehicle, or removed from the trailer that is attached to the vehicle.

19. The vehicle of claim 14, wherein the ADAS provides a first level of responsiveness to an action performed by a driver of the vehicle and wherein modifying the operation of the ADAS comprises changing the first level of responsiveness to a second level of responsiveness in proportion to the laden weight of the vehicle.

20. The vehicle of claim 19, wherein changing the first level of responsiveness to the second level of responsiveness comprises changing a first setting that is set by the driver of the vehicle to a second setting that is determined by the processor.
